(19) United States
(12) Patent Application Publication
(10) Pub. No.: US 2011/0061307 A1
(43) Pub. Date: Mar. 17, 2011

(54) Weather Strip for a Door of a Motor Vehicle and Method of Making Same

(75) Inventor: Guenther BRAEUHERR, Stammham (DE)

(73) Assignee: Bayerische Motoren Werke Aktiengesellschaft, Muenchen (DE)

(21) Appl. No.: 12/951,396

(22) Filed: Nov. 22, 2010

Related U.S. Application Data
(63) Continuation of application No. PCT/EP2009/004107, filed on Jun. 8, 2009.

(30) Foreign Application Priority Data
Jun. 11, 2008 (DE) 10 2008 027 877.7

(51) Int. Cl. B60J 10/04; B05D 1/36; B05D 1/14

(52) U.S. Cl. 49/475.1; 427/203

(57) ABSTRACT

A weather strip is provided for a door of a motor vehicle. The functional surfaces of the weather strip are provided with a coating. To minimize noise generation, an outer surface of the sealing lip of the weather strip has a double coating consisting of a flock coat and a sliding varnish.

### CROSS REFERENCE TO RELATED APPLICATIONS

This application is a continuation of PCT International Application No. PCT/EP2009/004107, filed Jun. 8, 2009, which claims priority under 35 U.S.C. §119 from German Patent Application No. DE 10 2008 027 877.7, filed Jun. 11, 2008, the entire disclosures of which are herein expressly incorporated by reference.

### BACKGROUND AND SUMMARY OF THE INVENTION

The invention relates to a weather strip (seal) for a door of a motor vehicle.

Weather strips are known which are arranged on a window frame of a door and have a sealing lip. The weather strips rest on an outer surface of a door opening of a vehicle body. The sealing lip may rest directly on the vehicle body section of the door opening.

In another specific embodiment, a trim strip or the like is mounted on the door opening. The sealing lip of the window frame weather strip rests on the outer surface of the trim strip. Noise generated, for example, by a “stick-slip” effect may occur between the outer surface of the door opening and the sealing lip of the window frame weather strip.

A weather strip for a vehicle frame structure is known from WO 2004/082974 A1, where the functional surfaces of the weather strip are coated with a sliding varnish or are flock-coated in order to avoid a “stick-slip effect”.

It is an object of the invention to create a weather strip for a door of a motor vehicle whereby noise generation is minimized.

This and other objects are achieved by a weather strip according to the invention for a door of a motor vehicle, the weather strip being arranged on a window frame of the door. The weather strip has a sealing lip which, in a closed condition of the door, rests against an outer surface of a body component of the motor vehicle. The outer surface of the sealing lip of the weather strip has a double coating consisting of a flock coat and a sliding varnish. This double coating reduces the coefficient of friction and thus a “stick-slip effect” during the closing of the door and when driving on uneven roads, which situation causes a relative movement between the door and the vehicle body.

In an advantageous embodiment, the outer surface of the sealing lip is adjoined by a flock coat. The flock-coated outer surface of the sealing lip is additionally coated with a sliding varnish layer.

A thickness t of the sliding varnish layer is advantageously in a range from 13 μm>t>4 μm.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a lateral view of a passenger car;

FIG. 2 is a cross-sectional view taken along Line I-I in FIG. 1, wherein, in a closed condition of the door, a sealing lip of a window frame weather strip rests directly on a vehicle body section of a door opening; and

FIG. 3 is a cross-sectional view taken along Line I-I in FIG. 1 of another embodiment, wherein a trim strip is arranged on a door opening, a sealing lip of a window frame of a door resting on the trim strip in the closed condition of the door 1.

### DETAILED DESCRIPTION OF THE DRAWINGS

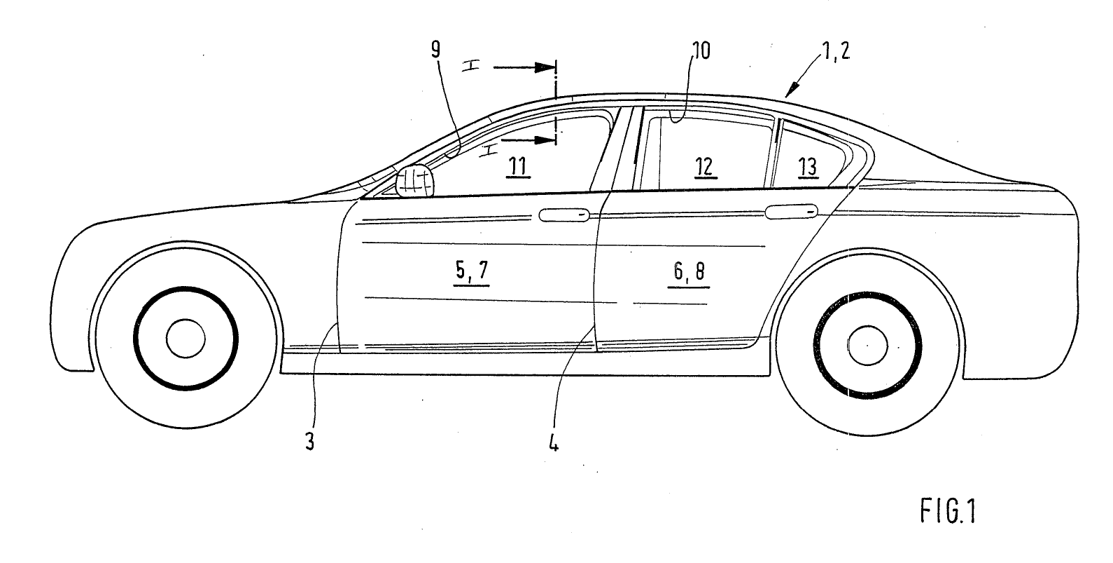

FIG. 1 is a lateral view of a motor vehicle 1. A forward door opening 3 and a rearward door opening 4 are constructed in a body 2 of the motor vehicle 1. A front door 5 and a rear door 6 are each hinged in the door openings 3, 4, respectively, in a known manner.

The respective door 5, 6 has a door body 7, 8 as well as a window frame 9, 10 in each case constructed at the respective door body 7, 8. One window pane 11, 12 respectively is displaceably arranged in the respective window frame 9, 10. Additionally, a rear window pane 13 is arranged in the window frame 10 at the rear door 6, which rear window pane 13 is, for example, arranged in a fixed or swivelable manner.

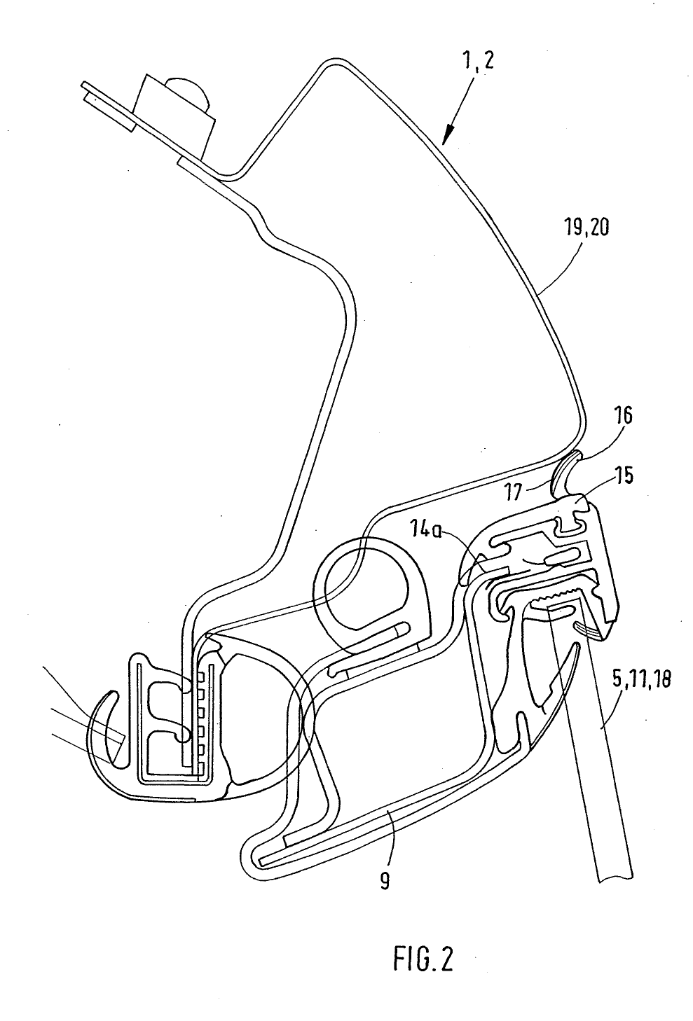

As illustrated in FIG. 2, a window frame weather strip 15 is fastened to a forward upper flange 14a of the window frame 9. The window frame weather strip 15 has a sealing lip 16. In the closed condition 18 of the door 5, the sealing lip 16 rests with an outer surface 17 against an outer surface 19 of a roof frame section 20 of the vehicle body 2.

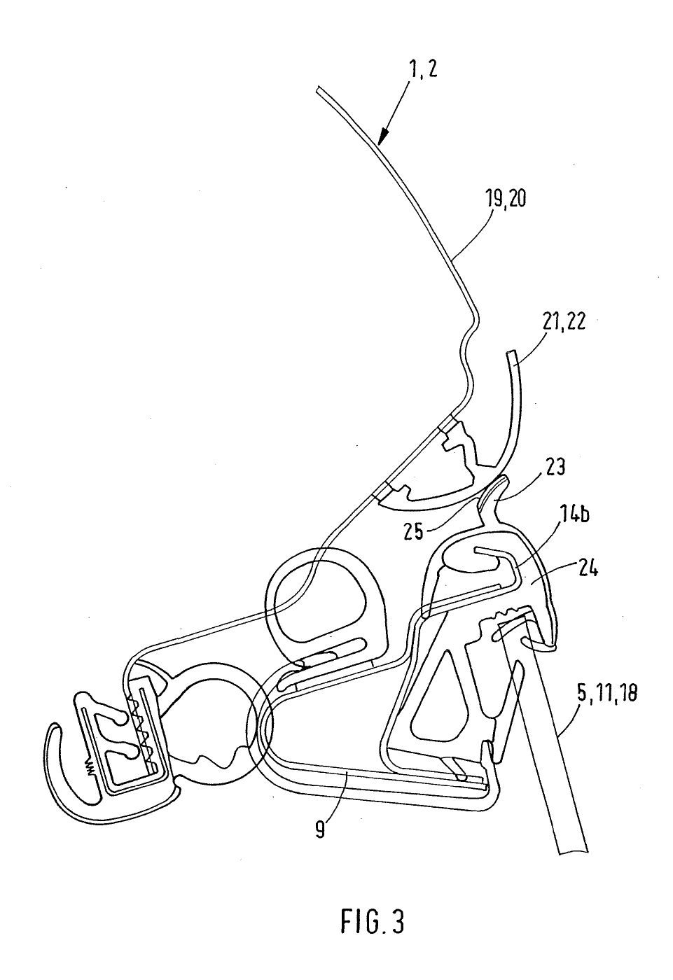

The cross-sectional view of FIG. 3 differs from the cross-sectional view of FIG. 2 essentially in that an additional trim strip 21 is arranged on the roof frame section 20. A sealing lip 23 of a window frame weather strip 24 rests against an outer surface 22 of the trim strip 21. The window frame weather strip 24 is fastened to a forward upper flange 14b of the window frame 9. In the closed condition 18 of the door 5, an outer surface 25 of the sealing lip 23 rests against the outer surface 22 of the trim strip 21.

The outer surface 17 of the sealing lip 16 and the outer surface 25 of the sealing lip 23, respectively, have a double coating. In an exemplary embodiment, a flock coat is first applied in a known manner to the respective outer surface 17, 25 of the sealing lip 16, 23. Subsequently, a further coating takes place by use of a sliding varnish.

In one embodiment, the flocks used for the flock coating have a length l of 0.4 mm<l<1.2 mm. The flocks are produced, for example, of polyoxymethelene (POM) or polyamide (PA). In an embodiment, the thickness t of the applied sliding varnish layer is at 13 μm>t>4 μm.

The layer thickness t of the sliding varnish depends on different parameters. These include, among others, the nature of the outer surface 19 of the roof frame section 20 and of the outer surface 22 of the trim strip 21 respectively. Also, in the case of a powder-coated outer surface 22 of the trim strip 21, which has an increased coefficient of friction, the double coating of the sealing lip 16, 23 results in the avoidance of a “stick-slip” effect.

Tests have shown that the double coating of the outer surface 17, 25 of the sealing lip 16, 23 leads to a continuous rise in strength along the predefined path during the closing of the door and the resulting location of the outer surface 17, 22 of the sealing lip 16, 23.

By use of the double coating of the outer surface 17, 25 of the sealing lip 16, 23, an adherence of the outer surface 17, 25 of the sealing lip 16, 23 on the outer surface 19 of the roof frame section 20 or on the outer surface 22 of the trim strip 21 is avoided for the lifetime of the sealing lip 16, 23. This also prevents the generation of noise.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A weather strip for a door of a motor vehicle, the weather strip being arrangeable on a window frame of the door, the weather strip comprising:
a sealing lip operatively configured to rest against an outer surface of a body component of the motor vehicle in a closed condition of the door; and
wherein the sealing lip has an outer surface with a double coating comprising a flock-coat layer and a sliding varnish coat layer.

2. The weather strip according to claim 1, wherein the flock-coat layer adjoins the outer surface of the sealing lip and the sliding varnish coat layer adjoins the flock-coat layer.

3. The weather strip according to claim 2, wherein a thickness of the sliding varnish coat layer is from 4 μm to 13 μm.

4. The weather strip according to claim 2, wherein flocks used in the flock-coat layer have a length of from 0.4 mm to 1.2 mm.

5. The weather strip according to claim 3, wherein flocks used in the flock-coat layer have a length of from 0.4 mm to 1.2 mm.

6. A method of making a weather strip arrangeable on a window frame of a door of a motor vehicle, the method comprising the acts of:
providing a weather strip with a sealing lip having an outer surface; and
double coating the outer surface of the sealing lip with a flock-coat layer and a sliding varnish layer.

7. The method according to claim 6, wherein the act of double coating comprises the acts of:
first coating the outer surface of the sealing lip with a flock-coat to provide a flock-coated outer surface of the sealing lip; and
second coating the flock-coated outer surface of the sealing lip with a sliding varnish.

8. The method according to claim 7, wherein the coating of the flock-coated outer surface of the sealing lip applies a sliding varnish layer with a thickness between 4 μm to 13 μm.

9. The method according to claim 6, wherein the coating of the outer surface of the sealing lip with a flock-coat applies flocks having a length of from 0.4 mm to 1.2 mm.

10. The method according to claim 7, wherein the coating of the outer surface of the sealing lip with a flock-coat applies flocks having a length of from 0.4 mm to 1.2 mm.
